(19) United States
(12) Patent Application Publication
(10) Pub. No.: US 2023/0103827 A1
(43) Pub. Date: Apr. 6, 2023

(54) NON-RECIPROCAL CIRCUIT ELEMENT AND COMMUNICATION APPARATUS

(71) Applicant: TDK Corporation, Tokyo (JP)

(72) Inventors: Kosuke SATO, Tokyo (JP); Hidenori OHATA, Tokyo (JP)

(21) Appl. No.: 17/953,770

(22) Filed: Sep. 27, 2022

(30) Foreign Application Priority Data
Oct. 4, 2021 (JP) 2021-163633

(51) Int. Cl. H01P 1/36; H01P 1/38; H01F 7/02

(52) U.S. Cl. CPC H01P 1/36; H01P 1/38; H01F 7/0273

(57) ABSTRACT

Disclosed herein is a non-reciprocal circuit element that includes a magnetic rotator and a permanent magnet that applies a magnetic field to the magnetic rotator. The magnetic rotator includes a ferrite core and a center conductor positioned between the ferrite core and the permanent magnet. The center conductor has an upper surface facing the permanent magnet, a side surface perpendicular to the upper surface, and an upper surface side corner part constituted by an end portion of the upper surface and one end portion of the side surface. A fillet is formed at the upper surface side corner part.

### BACKGROUND

### Field

The present disclosure relates to a non-reciprocal circuit element and a communication apparatus having the same and, more particularly, to a non-reciprocal circuit element having a structure in which a center conductor is sandwiched between a ferrite core and a permanent magnet and a communication apparatus having such a non-reciprocal circuit element.

### Description of Related Art

A non-reciprocal circuit element such as an isolator or a circulator, which is a kind of a magnetic device, has a magnetic rotator having a structure in which a center conductor and a ferrite core are stacked and a permanent magnet that applies a magnetic field to the magnetic rotator. In non-reciprocal circuit elements described in JP 2002-043808A and JP 2015-050689A, the center conductor is disposed so as to be sandwiched between the ferrite core and the permanent magnet.

The present inventor's studies have revealed that when local concentration of an electric field occurs in a center conductor included in a non-reciprocal circuit element, insertion loss disadvantageously increases.

### SUMMARY

one of the objectives of the present disclosure is to provide a non-reciprocal circuit element with low insertion loss and a communication apparatus having such a non-reciprocal circuit element.

A non-reciprocal circuit element according to one aspect of the present disclosure includes a magnetic rotator and a permanent magnet that applies a magnetic field to the magnetic rotator. The magnetic rotator includes a ferrite core and a center conductor positioned between the ferrite core and the permanent magnet. The center conductor has an upper surface facing the permanent magnet, a side surface perpendicular to the upper surface, and an upper surface side corner part constituted by the end portion of the upper surface and one end portion of the side surface, and a fillet is formed at the upper surface side corner part.

A communication apparatus according to the present disclosure includes the above-described non-reciprocal circuit element.

According to the present disclosure, a non-reciprocal circuit element with low insertion loss and a communication apparatus having such a non-reciprocal circuit element can be provided.

### BRIEF DESCRIPTION OF THE DRAWINGS

The above features and advantages of the present disclosure will be more apparent from the following description of certain embodiments taken in conjunction with the accompanying drawings, in which:

FIG. 1 is a schematic perspective view illustrating the outer appearance of a non-reciprocal circuit element 1 according to an embodiment of the present disclosure from the upper side;

FIG. 2 is a schematic perspective view illustrating the outer appearance of the non-reciprocal circuit element 1 according to the embodiment of the present disclosure from the lower side;

FIG. 3 is a schematic perspective view illustrating a state where a permanent magnet 20 and an upper yoke 30 are removed from the non-reciprocal circuit element 1;

FIG. 4 is a schematic plan view for explaining the structure of a magnetic rotator M;

FIG. 5 is a schematic perspective view for explaining the structure of the magnetic rotator M;

FIG. 6 is a schematic view for explaining the sectional shape of center conductors 81 to 83;

FIG. 7 is a schematic view for explaining the sectional shape of center conductors 81 to 83 according to a modification;

FIG. 8 is a graph illustrating the relation between the position of the fillet and insertion loss;

FIG. 9 is a graph illustrating the relation between the radius of the fillet and insertion loss;

FIGS. 10 and 11 are graphs each illustrating the relation between the fillet radius and deviation of the resonance frequency; and

FIG. 12 is a block diagram illustrating the configuration of a communication apparatus 100 using the non-reciprocal circuit element 1.

### DETAILED DESCRIPTION OF THE EMBODIMENTS

Some embodiments of the present disclosure will be explained below in detail with reference to the accompanying drawings.

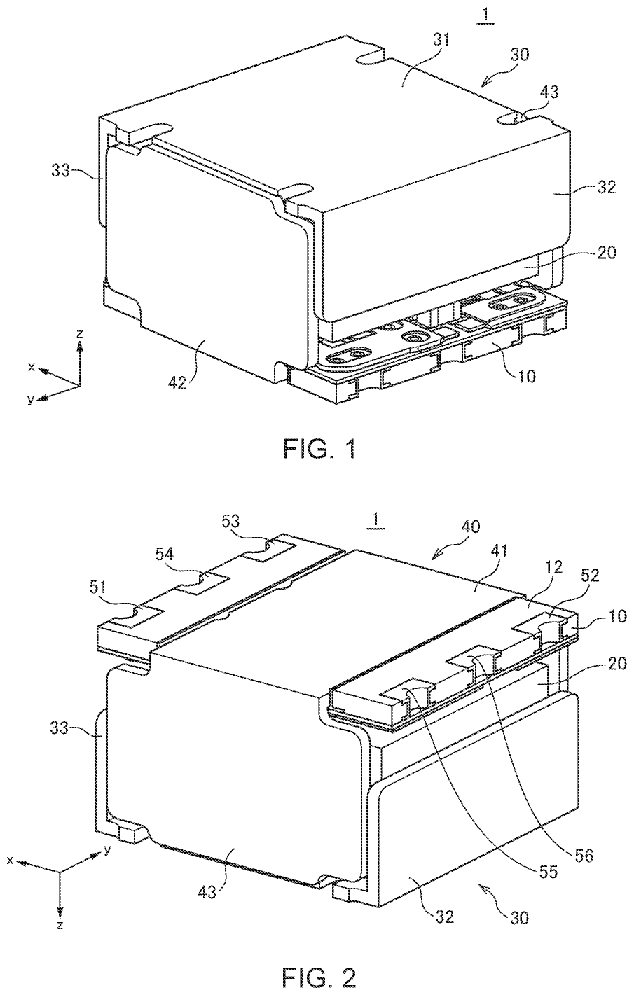

FIGS. 1 and 2 are schematic perspective views illustrating the outer appearance of a non-reciprocal circuit element 1 according to an embodiment of the present disclosure. FIG. 1 is a view from the upper side, and FIG. 2 is a view from the lower side.

The non-reciprocal circuit element 1 according to the present embodiment is a non-reciprocal circuit element of a surface mount type and includes, as illustrated in FIGS. 1 and 2, a dielectric substrate 10, a permanent magnet 20, an upper yoke 30, and a lower yoke 40. The dielectric substrate 10 and permanent magnet 20 are sandwiched between the upper and lower yokes 30 and 40. The dielectric substrate 10 has, on its lower surface 12, terminal electrodes 51 to 56. The upper yoke 30 has a top plate part 31 constituting the xy plane and folding parts 32 and 33 constituting the yz plane. The lower yoke 40 has a bottom plate part 41 constituting the xy plane and folding parts 42 and 43 constituting the xz plane. The folding parts 42 and 43 of the lower yoke 40 are fitted to the top plate part 31 of the upper yoke 30 to constitute a closed magnetic path.

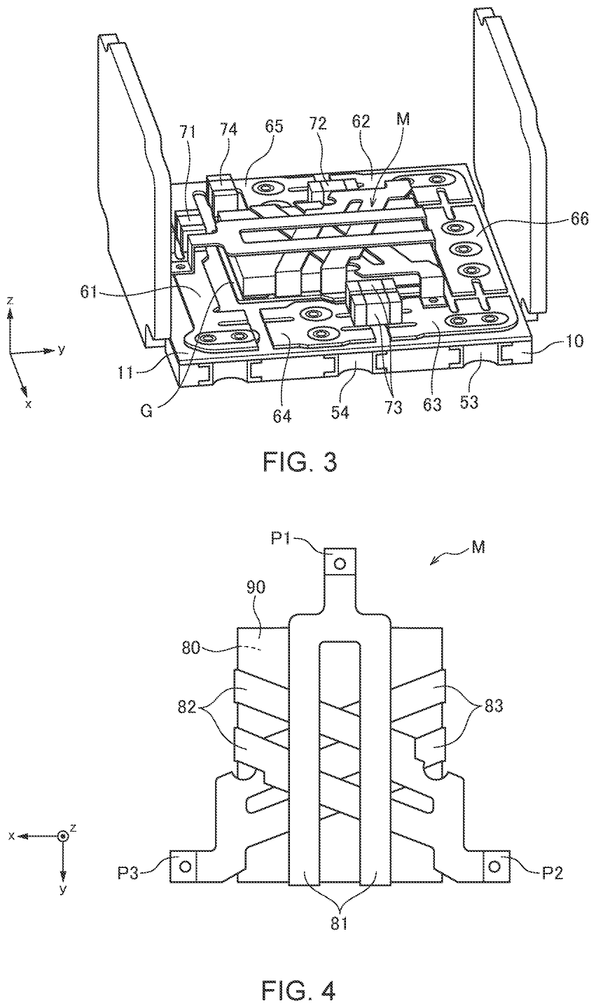

FIG. 3 is a schematic perspective view illustrating a state where the permanent magnet 20 and upper yoke 30 are removed from the non-reciprocal circuit element 1.

As illustrated in FIG. 3, the dielectric substrate 10 has, on its upper surface 11 constituting the xy plane, a magnetic rotator M. Further, connection patterns 61 to 65 are provided around the magnetic rotator M. The connection patterns 61 to 63 are connected respectively to ports P1 to P3 of the magnetic rotator M and then to terminal electrodes 51 to 53 through via conductors penetrating the dielectric substrate 10. The connection patterns 64 and 65 are connected to terminal electrodes 54 to 56, to which a ground potential is supplied, through via conductors penetrating the dielectric substrate 10. A chip type capacitor 71 is connected between the connection patterns 61 and 65, a chip type capacitor 72 is connected between the connection patterns 62 and 65, and a chip type capacitor 73 is connected between the connection patterns 63 and 64. With the above configuration, the ports P1 to P3 of the magnetic rotator M are connected to the ground respectively through the capacitors 71 to 73.

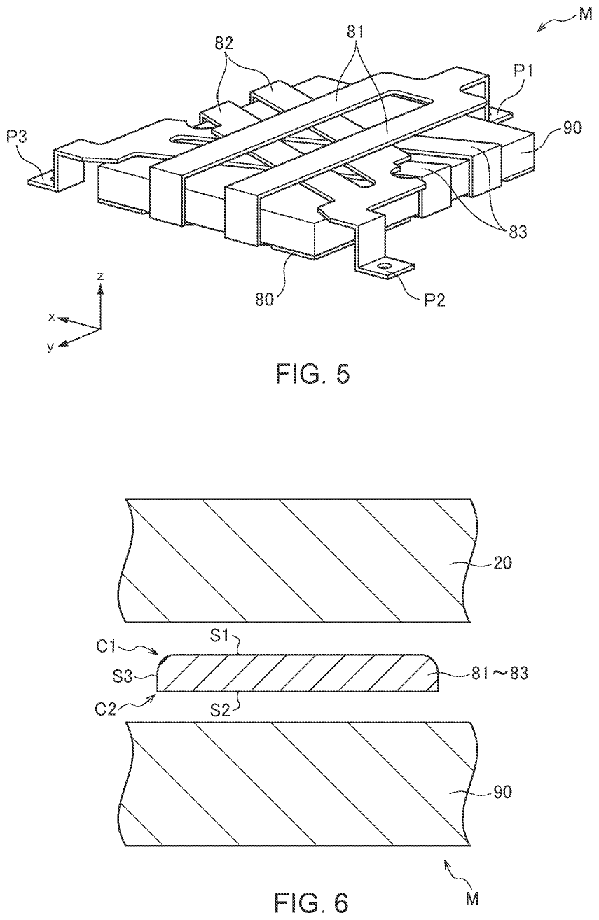

FIGS. 4 and 5 are a schematic plan view and a schematic perspective view for explaining the structure of the magnetic rotator M.

As illustrated in FIGS. 4 and 5, the magnetic rotator M has a ground conductor 80, center conductors 81 to 83, and a ferrite core 90. The center conductors 81 to 83 are each covered with an insulating film (which is omitted for easy understanding of the structure). The center conductors 81 to 83 are constituted by a plurality of metal conductors crossing one another at an angle of substantially 120°. In the example illustrated in FIGS. 4 and 5, the center conductors 81 to 83 are each constituted by two metal conductors. One ends of the center conductors 81 to 83 are connected respectively to the ports P1 to P3, and the other ends thereof are connected in common to the ground conductor 80 positioned on the back surface side of the ferrite core 90. Accordingly, the ferrite core 90 is sandwiched between the center conductors 81 to 83 and the ground conductor 80. The ground conductor 80 is connected to a ground pattern G provided on the surface of the dielectric substrate 10. A chip type capacitor 74 illustrated in FIG. 3 is connected between the ground pattern G and the connection pattern 65.

With the above configuration, the center conductor 81 is connected to the terminal electrode 51 through the connection pattern 61, the center conductor 82 is connected to the terminal electrode 52 through the connection pattern 62, the center conductor 83 is connected to the terminal electrode 53 through the connection pattern 63. Further, the ground conductor 80 is connected to the terminal electrodes 54 to 56 through the connection patterns 64 and 65.

FIG. 6 is a schematic view for explaining the sectional shape of the center conductors 81 to 83.

As illustrated in FIG. 6, the center conductors 81 to 83 have an upper surface S1 facing the permanent magnet 20, a lower surface S2 facing the ferrite core 90, and a side surface S3 perpendicular to the upper and lower surfaces S1 and S2. The upper and lower surfaces S1 and S2 constitute the xy plane, and the side surface S3 extends in the z-direction. In the example illustrated in FIG. 6, a fillet is formed at an upper surface side corner part C1 constituted by the end portion of the upper surface S1 of the center conductors 81 to 83 and one end portion of the side surface S3. On the other hand, the fillet is not formed at a lower surface side corner part C2 constituted by the end portion of the lower surface S2 of the center conductors 81 to 83 and the other end portion of the side surface S3. That is, the fillet is formed at the corner on the permanent magnet 20 side and not formed at the corner on the ferrite core 90 side.

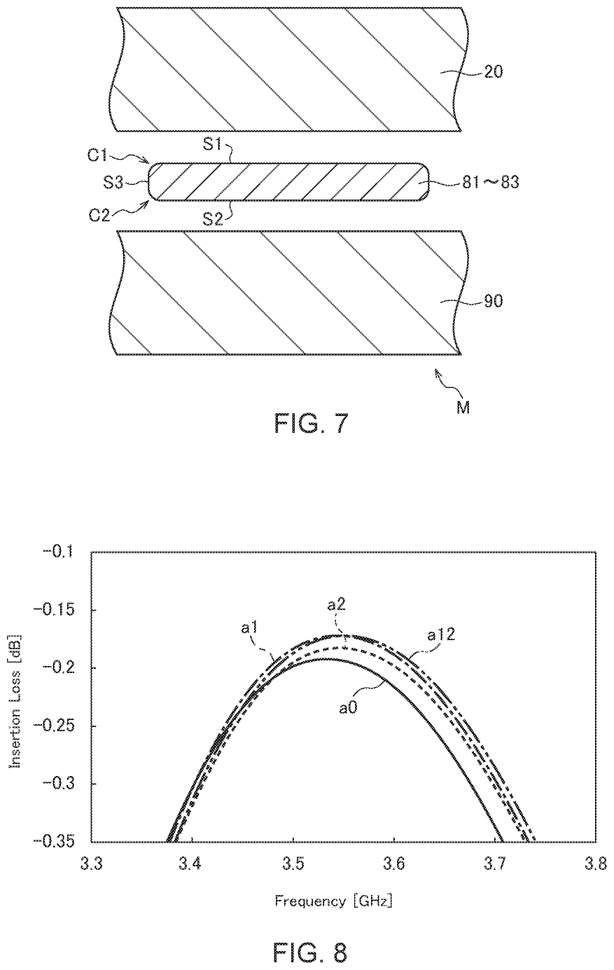

Such a sectional shape alleviates local concentration of an electric field on the upper surface side corner part C1 of the center conductors 81 to 83, with the result that the non-reciprocal circuit element 1 has reduced insertion loss. Concentration of an electric field occurs also on the lower surface side corner part C2, so that, as illustrated in FIG. 7, which is a modification of FIG. 6, the fillet may be formed at the lower surface side corner part C2 in addition to the upper surface side corner part C1. However, formation of the fillet only at the lower surface side corner part C2 may not sufficiently reduce insertion loss. Thus, the fillet at least at the upper surface side corner part C1 may be formed to sufficiently reduce insertion loss. When a resonance frequency is about 3.5 GHz, the fillet to be formed at the upper surface side corner part C1 may have a radius of 2 μm or more in order to sufficiently reduce insertion loss. However, when the radius of the fillet is excessively large, the sectional area of the center conductors 81 to 83 decreases, and the resonance frequency markedly deviates from a designed value of resonance frequency. Therefore, the fillet radius may not be enlarged to such a degree that the vertical portion of the side surface S3 is eliminated.

FIG. 8 is a graph illustrating the relation between the position of the fillet and insertion loss. In the graph, a curve al represents a characteristic when the fillet is formed at the upper surface side corner part C1 of the center conductors 81 to 83, a curve a2 represents a characteristic when the fillet is formed at the lower surface side corner part C2 of the center conductors 81 to 83, a curve a12 represents a characteristic when the fillet is formed both at the upper surface side corner part C1 and the lower surface side corner part C2 of the center conductors 81 to 83, and a curve a0 represents a characteristic when the fillet is formed neither at the upper surface side corner part C1 nor the lower surface side corner part C2 of the center conductors 81 to 83. In either of the above cases, the radius of the fillet is set to 10 μm.

As can be seen from the graph of FIG. 8, when the fillet is formed at the upper surface side corner part C1 or lower surface side corner part C2 of the center conductors 81 to 83, insertion loss decreases as compared to a case where the fillet is absent. The reduction effect of insertion loss is conspicuous when the fillet is formed at the upper surface side corner part C1, while it is low when the fillet is formed only at the lower surface side corner part C2, as represented by the curve a2.

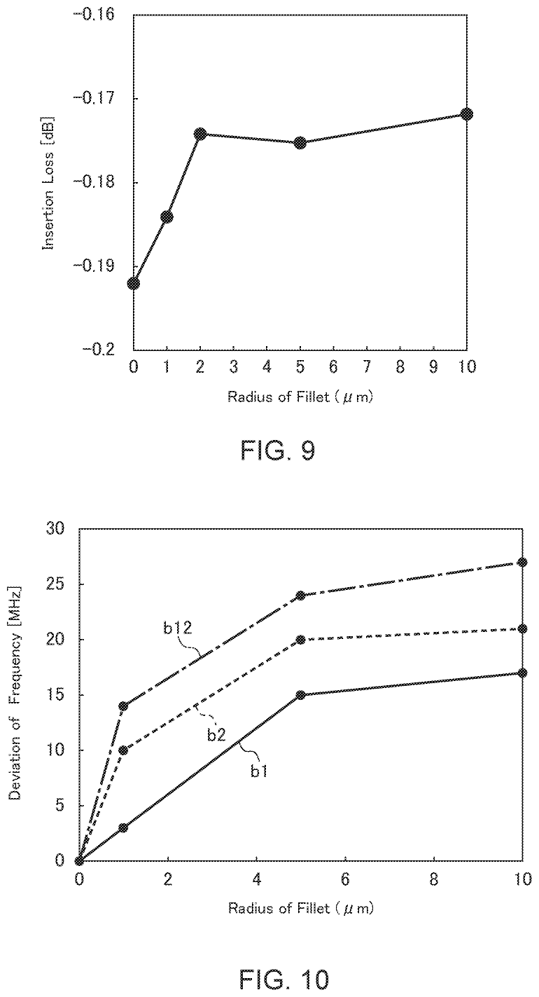

FIG. 9 is a graph illustrating the relation between the radius of the fillet and insertion loss. Like the curve al in the graph of FIG. 8, the solid line in the graph of FIG. 9 represents a characteristic when the fillet is formed only at the upper surface side corner part C1 of the center conductors 81 to 83.

As can be seen from the graph of FIG. 9, the insertion loss reduction effect is conspicuous when the fillet radius is 2 μm or more. However, even when the fillet radius is increased to more than 2 μm, the insertion loss reduction effect saturates. Therefore, in order to sufficiently allocate the sectional area of the center conductors 81 to 83, the fillet radius may not be enlarged to such a degree that the vertical portion of the side surface S3 is eliminated.

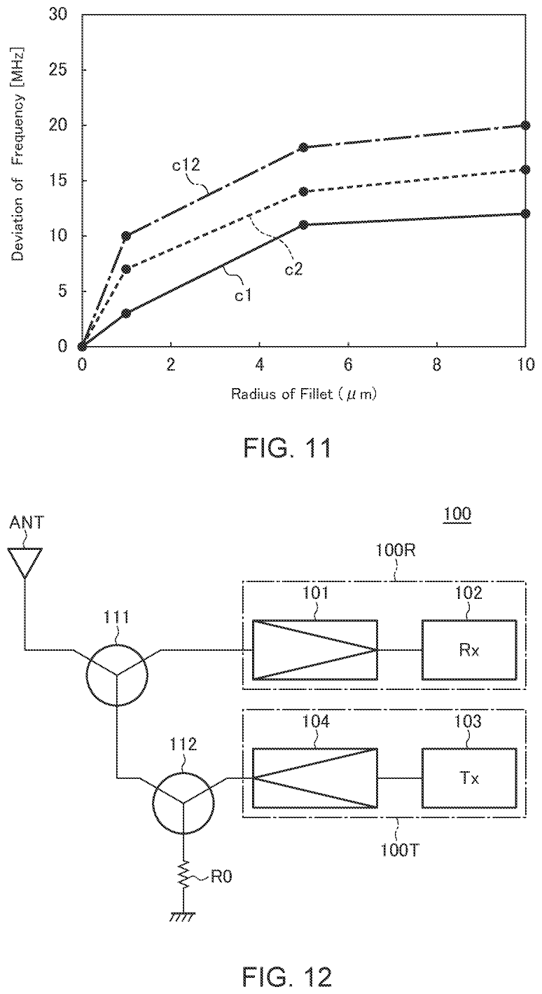

FIGS. 10 and 11 are graphs each illustrating the relation between the fillet radius and deviation of the resonance frequency. The graph of FIG. 10 illustrates reflection characteristics at the port P2, and the graph of FIG. 11 illustrates passage characteristics from the port P2 to the port P1. In the graphs of FIGS. 10 and 11, curves bl and cl represent characteristics when the fillet is formed at the upper surface side corner part C1 of the center conductors 81 to 83, curves b2 and c2 represent characteristics when the fillet is formed at the lower surface side corner part C2 of the center conductors 81 to 83, and curves b12 and c12 represent characteristics when the fillet is formed both at the upper surface side corner part C1 and lower surface side corner part C2 of the center conductors 81 to 83.

As can be seen from the graphs of FIGS. 10 and 11, when the fillet is formed on the center conductors 81 to 83, the larger the fillet radius is, the greater the deviation of the resonance frequency from a designed value becomes. Assuming that the fillet radius is the same, the deviation of the resonance frequency becomes maximum when the fillet is formed both at the upper surface side corner part C1 and lower surface side corner part C2 (curves b12 and c12) and becomes minimum when the fillet is formed only at the upper surface side corner part C1 (curves b1 and c1).

FIG. 12 is a block diagram illustrating the configuration of a communication apparatus 100 using the non-reciprocal circuit element 1 according to the present embodiment.

A communication apparatus 100 illustrated in FIG. 12 is provided in, for example, a base station of a mobile communication system. The communication apparatus 100 incudes a receiving circuit part 100R and a transmitting circuit part 100T which are connected to an antenna ANT for transmission and reception. The receiving circuit part 100R includes a reception amplification circuit 101 and a receiving circuit 102 for processing a received signal. The transmitting circuit part 100T includes a transmitting circuit 103 for generating an audio signal and a video signal and a power amplification circuit 104.

In the thus configured communication apparatus 100, non-reciprocal circuit elements 111 and 112 are inserted respectively into a path between the antenna ANT and the receiving circuit part 100R and a path between the transmitting circuit part 100T and the antenna ANT. The non-reciprocal circuit elements 111 and 112 may each be the non-reciprocal circuit element 1 according to the above embodiment. In the example illustrated in FIG. 12, the non-reciprocal circuit element 111 functions as a circulator, and the non-reciprocal circuit element 112 functions as an isolator including a terminal resistor RO.

As described above, according to the present embodiment, the fillet is formed at the upper surface side corner part of the center conductor, so that it is possible to alleviate local concentration of an electric field on the upper surface side corner part where the local concentration of an electric field largely affects insertion loss.

For example, the radius of the fillet at the upper surface side corner part may be 2 μm or more. This makes it possible to sufficiently reduce insertion loss.

For example, the center conductor may further have a lower surface facing the ferrite core and a lower surface side corner part constituted by the end portion of the lower surface and the other end portion of the side surface, and a fillet may be formed at the lower surface side corner part. This makes it possible to further reduce insertion loss.

For example, the center conductor may further have a lower surface facing the ferrite core and a lower surface side corner part constituted by the end portion of the lower surface and the other end portion of the side surface, and a fillet may not be formed at the lower surface side corner part. This makes it possible to suppress deviation of a resonance frequency due to the presence of the fillet.

As described above, according to the present embodiment, a non-reciprocal circuit element with low insertion loss and a communication apparatus having such a non-reciprocal circuit element is able to be provided.

While the one embodiment of the present disclosure has been described, the present disclosure is not limited to the above embodiment, and various modifications may be made within the scope of the present disclosure, and all such modifications are included in the present disclosure.

What is claimed is:

1. A non-reciprocal circuit element comprising:
a magnetic rotator; and
a permanent magnet that applies a magnetic field to the magnetic rotator,
wherein the magnetic rotator includes a ferrite core and a center conductor positioned between the ferrite core and the permanent magnet,
wherein the center conductor has an upper surface facing the permanent magnet, a side surface perpendicular to the upper surface, and an upper surface side corner part constituted by an end portion of the upper surface and one end portion of the side surface, and
wherein a fillet is formed at the upper surface side corner part.

2. The non-reciprocal circuit element as claimed in claim 1, wherein a radius of the fillet at the upper surface side corner part is 2 μm or more.

3. The non-reciprocal circuit element as claimed in claim 1,
wherein the center conductor further has a lower surface facing the ferrite core and a lower surface side corner part constituted by an end portion of the lower surface and other end portion of the side surface, and
wherein a fillet is formed at the lower surface side corner part.

4. The non-reciprocal circuit element as claimed in claim 1,
wherein the center conductor further has a lower surface facing the ferrite core and a lower surface side corner part constituted by an end portion of the lower surface and other end portion of the side surface, and
wherein a fillet is not formed at the lower surface side corner part.

5. A communication apparatus including a non-reciprocal circuit element, the non-reciprocal circuit element comprising:
a magnetic rotator; and
a permanent magnet that applies a magnetic field to the magnetic rotator,
wherein the magnetic rotator includes a ferrite core and a center conductor positioned between the ferrite core and the permanent magnet,
wherein the center conductor has an upper surface facing the permanent magnet, a side surface perpendicular to the upper surface, and an upper surface side corner part constituted by an end portion of the upper surface and one end portion of the side surface, and
wherein a fillet is formed at the upper surface side corner part.

6. The non-reciprocal circuit element as claimed in claim 2,
wherein the center conductor further has a lower surface facing the ferrite core and a lower surface side corner part constituted by an end portion of the lower surface and other end portion of the side surface, and
wherein a fillet is formed at the lower surface side corner part.

7. The non-reciprocal circuit element as claimed in claim 2,
wherein the center conductor further has a lower surface facing the ferrite core and a lower surface side corner part constituted by an end portion of the lower surface and other end portion of the side surface, and
wherein a fillet is not formed at the lower surface side corner part.

8. The communication apparatus as claimed in claim 5, wherein a radius of the fillet at the upper surface side corner part is 2 μm or more.

9. The communication apparatus as claimed in claim 5,
wherein the center conductor further has a lower surface facing the ferrite core and a lower surface side corner part constituted by an end portion of the lower surface and other end portion of the side surface, and
wherein a fillet is formed at the lower surface side corner part.

10. The communication apparatus as claimed in claim 5,
wherein the center conductor further has a lower surface facing the ferrite core and a lower surface side corner part constituted by an end portion of the lower surface and other end portion of the side surface, and
wherein a fillet is not formed at the lower surface side corner part.
